(19) United States
(12) Patent Application Publication
(10) Pub. No.: US 2025/0174393 A1
(43) Pub. Date: May 29, 2025

(54) INDUCTOR

(71) Applicant: CHILISIN ELECTRONICS CORP., TAOYUAN CITY (TW)

(72) Inventor: CHUN-CHIH LIN, TAOYUAN CITY (TW)

(21) Appl. No.: 18/981,649

(22) Filed: Dec. 16, 2024

Related U.S. Application Data
(63) Continuation-in-part of application No. 18/595,306, filed on Mar. 4, 2024.

(30) Foreign Application Priority Data
Nov. 23, 2023 (TW) 112145303
Nov. 22, 2024 (TW) 113145034

(51) Int. Cl. H01F 27/29; H01F 3/08; H01F 5/04

(52) U.S. Cl. CPC H01F 27/292; H01F 5/04; H01F 3/08

(57) ABSTRACT

An inductor includes a magnetic body, a plurality of single-piece coils, an electrode structure and a protective structure. The magnetic body has a bottom surface. The single-piece coils are embedded in the magnetic body and are spaced apart from each other. Each of the single-piece coils has a first end portion and a second end portion that are exposed from the bottom surface. The electrode structure is disposed on the bottom surface and includes a plurality of first electrodes and second electrodes. The first electrodes are spaced apart from each other and electrically coupled to first end portions of the single-piece coils respectively. The second electrodes are spaced apart from each other and electrically coupled to the second end portions of the single-piece coils respectively. The protective structure is disposed on the bottom surface. The first electrodes and the second electrodes are separated by the protective structure.

### CROSS-REFERENCE TO RELATED PATENT APPLICATION

This application claims the benefit of priority to Taiwan Patent Application No. 113145034, filed on Nov. 22, 2024. The entire content of the above identified application is incorporated herein by reference.

This application is a Continuation-In-Part of the U.S. application Ser. No. 18/595,306, filed on Mar. 4, 2024, which claims the priority of Taiwan patent application serial no. 112145303, filed on Nov. 23, 2023. The entirety of each of the above-mentioned patent applications is hereby incorporated by reference herein and made as a part of this specification.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a circuit element, and more particularly to an inductor.

### BACKGROUND OF THE DISCLOSURE

An inductor is a type of circuit element that generates electromotive force in response to changes in current, so as to resist changes in the current. Hence, the inductor is often installed in electronic devices. Since modern electronic devices tend to have high computing power requirements (such as A.I. application servers), circuit power consumption of electronic devices has grown exponentially. Therefore, improving the power density of modern inductors such as to make them more efficient is an urgent issue to be addressed in the relevant industry.

### SUMMARY OF THE DISCLOSURE

In response to the above-referenced technical inadequacy, the present disclosure provides an inductor.

In order to solve the above-mentioned problems, one of the technical aspects adopted by the present disclosure is to provide an inductor. The inductor includes a magnetic body, a plurality of single-piece coils, an electrode structure, and a protective structure. The magnetic body has a bottom surface. The single-piece coils are embedded in the magnetic body. The single-piece coils are spaced apart from each other, each of the single-piece coils includes a first end portion and a second end portion, and the first end portion and the second end portion are exposed from the bottom surface. The electrode structure is disposed on the bottom surface of the magnetic body. The electrode structure includes a plurality of first electrodes and a plurality of second electrodes. The first electrodes are spaced apart from each other. The first electrodes are respectively and electrically coupled to the first end portions of the single-piece coils. The second electrodes are spaced apart from each other. The second electrodes are respectively and electrically coupled to the second end portions of the single-piece coils. The protective structure is disposed on the bottom surface of the magnetic body. The first electrodes and the second electrodes are separated by the protective structure.

Therefore, in the inductor provided by the present disclosure, by virtue of “the single-piece coils being embedded in the magnetic body and being spaced apart from each other” and “the first end portion and the second end portion being exposed from the bottom surface,” the inductor can have higher power density under the same volume, so as to improve power conversion efficiency.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic perspective view of an inductor according to one embodiment of the present disclosure;

FIG. 2 is another schematic perspective view of the inductor according to one embodiment of the present disclosure;

FIG. 3 is a schematic cross-sectional view taken along line III-III of FIG. 1;

FIG. 4 is a schematic top view of the inductor according to one embodiment of the present disclosure;

FIG. 5 is a schematic bottom view of the inductor according to one embodiment of the present disclosure;

FIG. 6 is schematic view of the inductor provided with an electrode structure in another configuration according to one embodiment of the present disclosure;

FIG. 7 is schematic view of the inductor provided with a protective structure in another configuration according to one embodiment of the present disclosure;

FIG. 8 is schematic view of the inductor according to one embodiment of the present disclosure in another implementation;

FIG. 9 is schematic view of the inductor according to one embodiment of the present disclosure in yet another implementation;

FIG. 10 is a schematic top view of the inductor in FIG. 9;

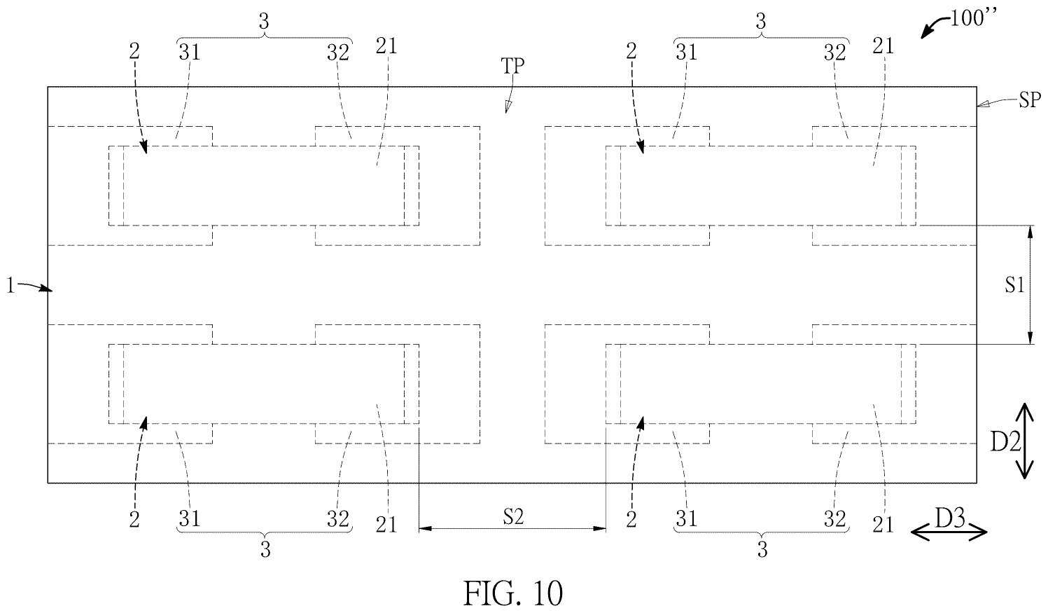

FIG. 11 is a schematic bottom view of the inductor in FIG. 9;

FIG. 12 is schematic view of a plurality of single-piece coils in another configuration embedded in a magnetic body according to one embodiment of the present disclosure;

FIG. 13 is schematic view of a plurality of single-piece coils in yet another configuration embedded in the magnetic body according to one embodiment of the present disclosure;

FIG. 14 is schematic view of a plurality of single-piece coils in two configurations embedded in the magnetic body according to one embodiment of the present disclosure;

FIG. 15 is schematic view of the inductor in FIG. 7 provided with the protective structure in yet another configuration according to one embodiment of the present disclosure; and

FIG. 16 is schematic view of the inductor according to one embodiment of the present disclosure in still another implementation.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

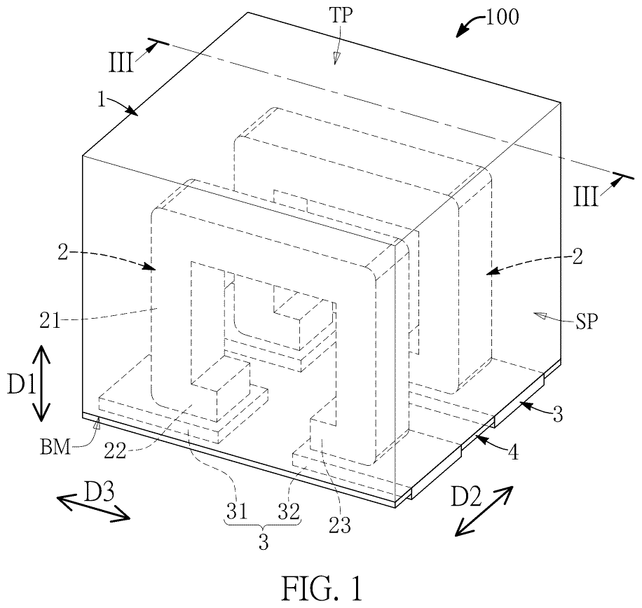

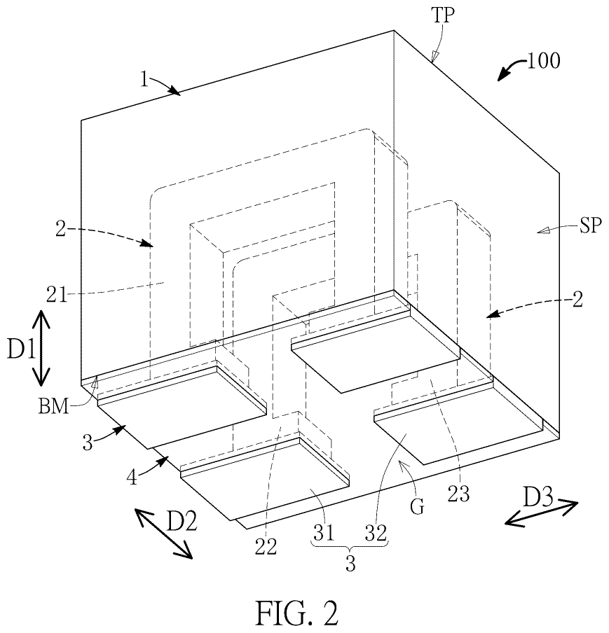

Referring to FIG. 1 to FIG. 7, the present embodiment provides an inductor 100. As shown in FIG. 1 and FIG. 2, the inductor 100 includes a magnetic body 1, a plurality of single-piece coils 2 embedded in the magnetic body 1, and an electrode structure 3 and a protective structure 4 that are disposed on a surface of the magnetic body 1. The following description describes the structure and connection relation of each component of the inductor 100.

Referring to FIG. 1 to FIG. 3, the magnetic body 1 in the present embodiment can be exemplified as a rectangular body, but the present disclosure is not limited thereto. For example, in certain embodiments of the present disclosure (not shown), the magnetic body may also be a hexahedron or other three-dimensional structures.

In addition, the magnetic body 1 has a first direction D1, a second direction D2 perpendicular to the first direction D1, and a third direction D3 that is perpendicular to the first direction D1 and the second direction D2. For ease of understanding, the first direction D1 is defined as a Z-axis direction of the magnetic body in FIG. 1, the second direction D2 is defined as a Y-axis direction of the magnetic body in FIG. 1, the third direction D3 is defined as an X-axis direction of the magnetic body in FIG. 1, and one side of the magnetic body 1 parallel to the XY plane is defined as a bottom surface BM. In other words, the magnetic body 1 has the bottom surface BM when observed along the first direction D1. Moreover, the magnetic body 1 further includes a top surface TP opposite to the bottom surface BM, and a surrounding surface SP that is connected to the bottom surface BM and the top surface TP.

Preferably, a material of the magnetic body 1 may, in practice, include metal magnetic powder and adhesive components (i.e., the magnetic body 1 is a mixture of metal magnetic powder and adhesive components), and the magnetic body 1 may be fabricated using a compression molding process.

The metal magnetic powder may further include at least one of crystalline metal magnetic powder and amorphous metal magnetic powder. For example, the crystalline metal magnetic powder may include, but is not limited to, iron-silicon alloy powder, iron-silicon-chromium alloy powder, iron-silicon-aluminum alloy powder, iron-nickel alloy powder, carbonyl iron powder, iron powder, iron-nickel-molybdenum alloy powder, or iron-cobalt-vanadium alloy powder. The amorphous metal magnetic powder may include, but is not limited to, iron-silicon-boron-carbon powder or iron-silicon-chromium-boron-phosphorus-carbon powder. In addition, the adhesive component may include, but is not limited to, epoxy resin, acrylic resin, or silicone.

Referring to FIG. 1 and FIG. 2, the single-piece coils 2 are disposed in the magnetic body 1, and are spaced apart from each other. For convenience of explanation, a relationship of the single-piece coils 2 within the magnetic body 1 will first be described, and then the components of each of the single-piece coils 2 and their connection relationships will be described.

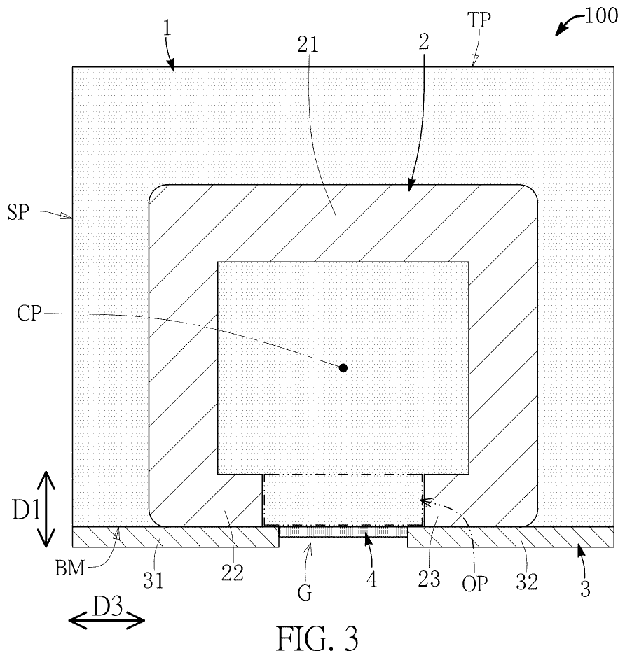

Referring to FIG. 1 and FIG. 3, each of the single-piece coils 2 is an open coil with an opening OP, and the openings OP of the single-piece coils 2 are oriented in the same direction (i.e., toward the bottom surface BM). As a result, an electromotive force in the same direction can be generated between two adjacent ones of the single-piece coils 2.

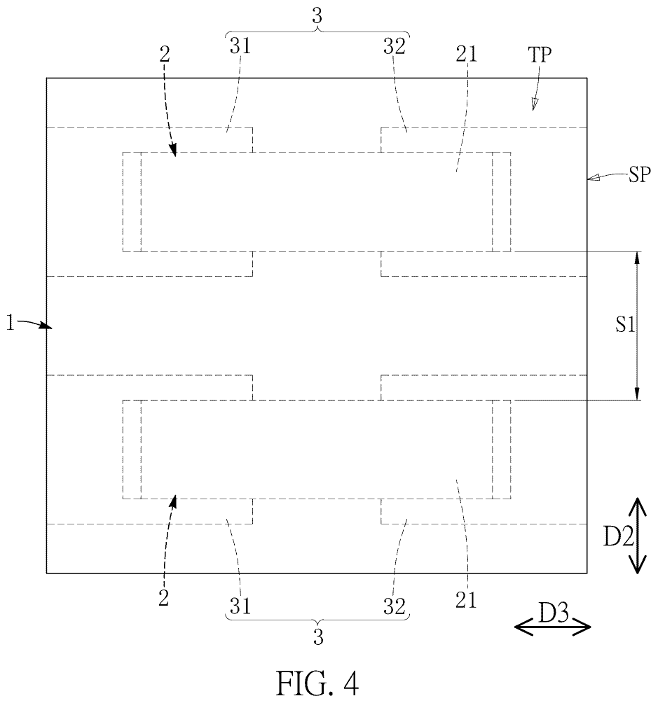

In addition, in the present embodiment, the single-piece coils 2 are spaced apart from each other along the second direction D2, and two adjacent ones of the single-piece coils 2 have a first minimum separation distance S1 along the second direction D2 (as shown in FIG. 1 and FIG. 4).

In response to the demand for miniaturization, the first minimum separation distance S1 of the inductor 100 may optionally range from 0.01 millimeters to 10 millimeters to prevent unintended voltage or current variations between two adjacent ones of the single-piece coils 2. In a preferred embodiment, the first minimum separation distance S1 can be within a range from 0.1 millimeters to 1 millimeter, but the present disclosure is not limited thereto.

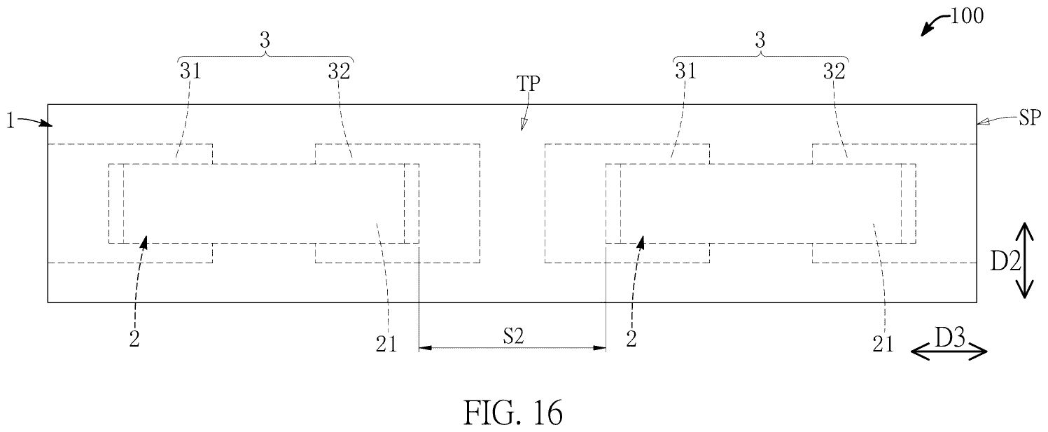

It is worth noting that the single-piece coils 2 of the present disclosure are not limited to being configured with spacing between each other along the second direction D2. Specifically, as shown in FIG. 16, the single-piece coils 2 can also be spaced apart from each other along the third direction D3 according to practical requirements.

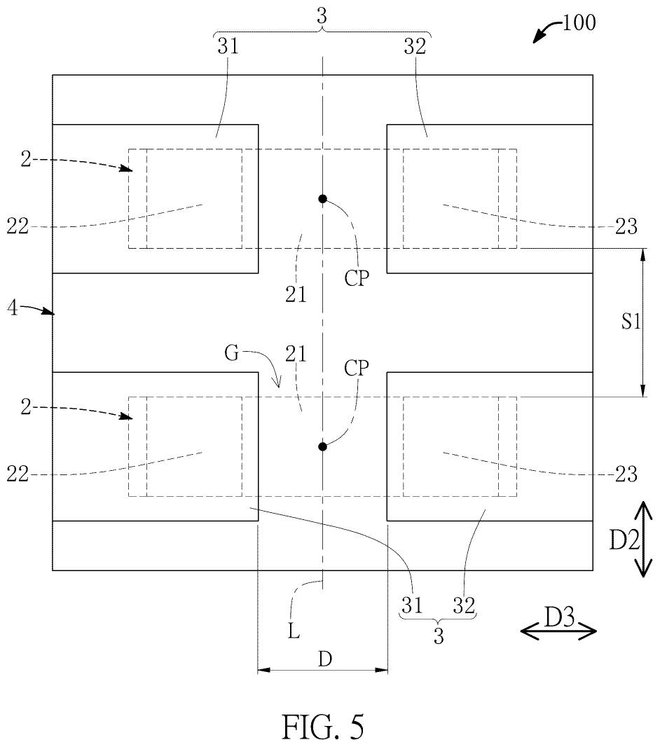

Referring again to FIG. 3 and FIG. 5, in one embodiment, a cross-section of each of the single-piece coils 2 along the first direction D1 is in a semi-enclosed geometric shape with a center point CP. The center points CP of the single-piece coils can be intersected by a configuration line L parallel to the second direction D2, but the present disclosure is not limited thereto. For example, the center points CP of the single-piece coils 2 can also be configured adjacent to the configuration line L without being intersected thereby.

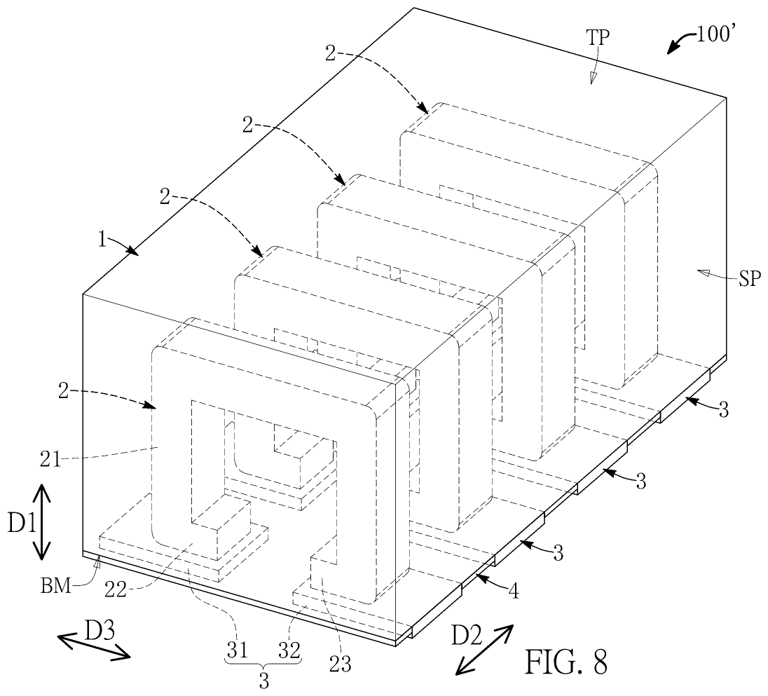

It should be specifically noted that in FIG. 1, two of the single-piece coils 2 are shown as an example, but in practice, a quantity of the single-piece coils 2 can be increased along the second direction D2 according to practical requirements (for example, as shown in the inductor 100′ in FIG. 8).

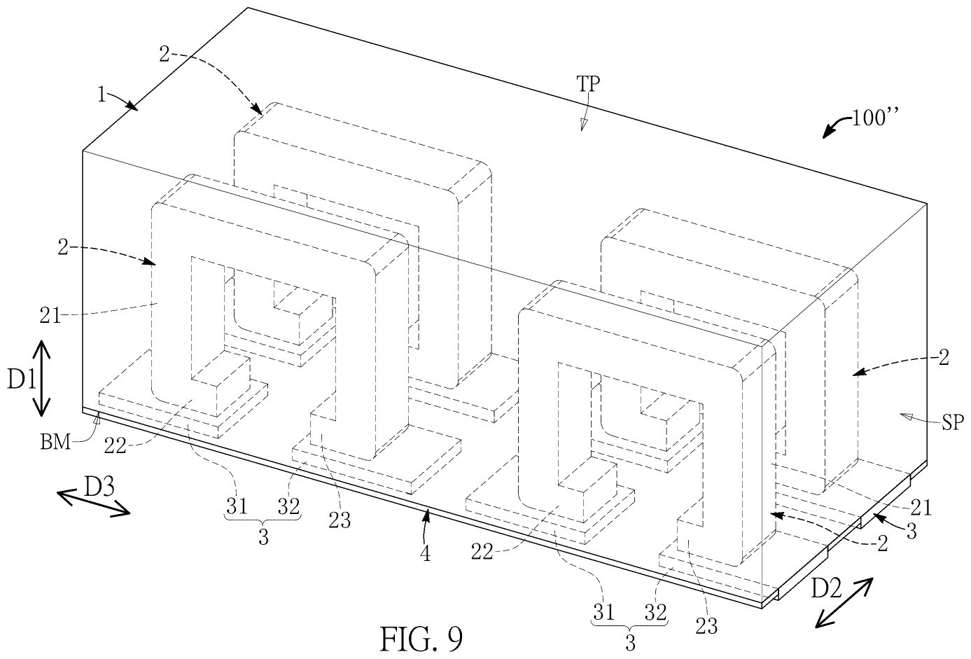

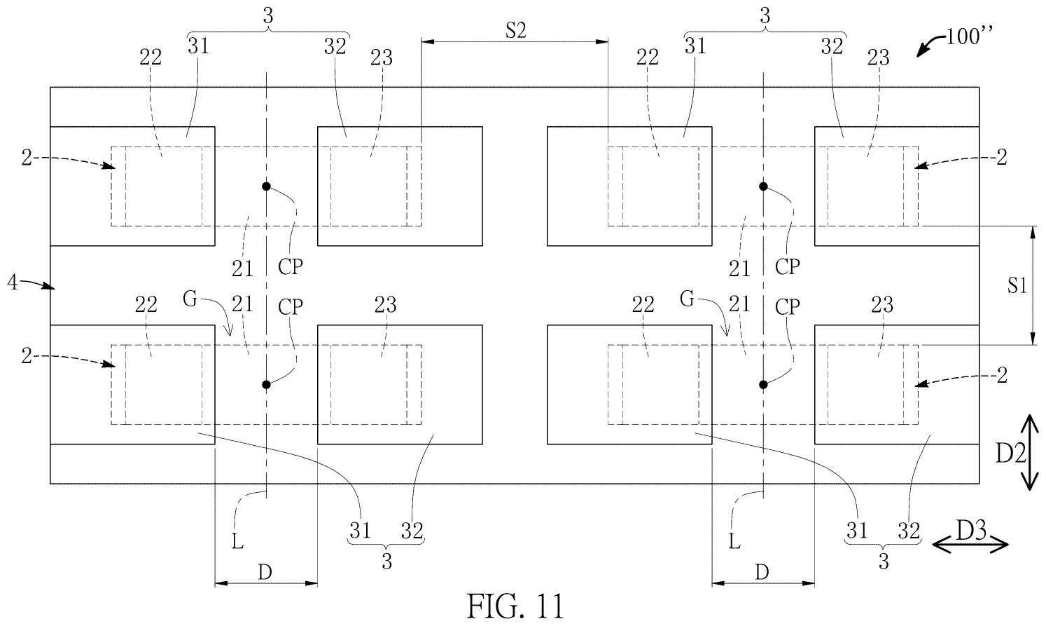

Moreover, the quantity of the single-piece coils 2 can also be increased along the third direction D3 (for example, as shown in the inductor 100″ in FIG. 9). In other words, the single-piece coils 2 can be spaced apart from each other along both the second direction D2 and the third direction D3. Two adjacent ones of the single-piece coils 2 along the third direction D3 also have a second minimum separation distance S2. The second minimum separation distance S2 is optionally within a range from 0.01 millimeters to 10 millimeters (as shown in FIG. 11). Optionally, in a preferred embodiment, the second minimum separation distance S2 can be within a range from 0.1 millimeters to 1 millimeter, but the present disclosure is not limited thereto.

It should be noted that when the inductor 100 is in its most miniaturized form, the second minimum separation distance S2 in the embodiments of the present disclosure will be greater than the first minimum separation distance S1. In another embodiment of the present disclosure (not shown), the second minimum separation distance S2 may also be less than the first minimum separation distance S1.

The above describes the configuration relationship of the single-piece coils 2 within the magnetic body 1. Next, the structure and connection relation of each component of the single-piece coils 2 will be introduced.

Referring again to FIG. 1 to FIG. 3, in the present embodiment, each of the single-piece coils 2 is a C-shaped structure made of a single material with a rectangular cross-section, and each of the single-piece coils 2 is not a coupled coil, but the present disclosure is not limited thereto. For example, in certain embodiments of the present disclosure (not shown), each of the single-piece coils 2 can also be a circular, triangular, or other polygonal structures, and the cross-section of each of the single-piece coils 2 can also be circular or of other shapes.

More specifically, each of the single-piece coils 2 is an open-type coil, and each of the single-piece coils 2 has a main body portion 21 being in a C-shape, and a first end portion 22 and a second end portion 23 that are connected to two ends of the main body portion 21. The first end portion 22 and the second end portion 23 of each of the single-piece coils 2 are spaced apart from each other along the third direction D3 without being connected, so that each of the single-piece coil 2 can be an open circuit and has an opening OP between the first end portion 22 and the second end portion 23.

In practice, each of the single-piece coils 2 can optionally be a symmetrical structure, and the first end portion 22 and the second end portion 23 of each of the single-piece coils 2 can be adjusted in orientation according to practical requirements.

In one embodiment, as shown in FIG. 3, the two ends of each of the single-piece coils 2 can be bent inward, so that the first end portion 22 and the second end portion 23 extend from the main body portion 21 toward each other along the third direction D3.

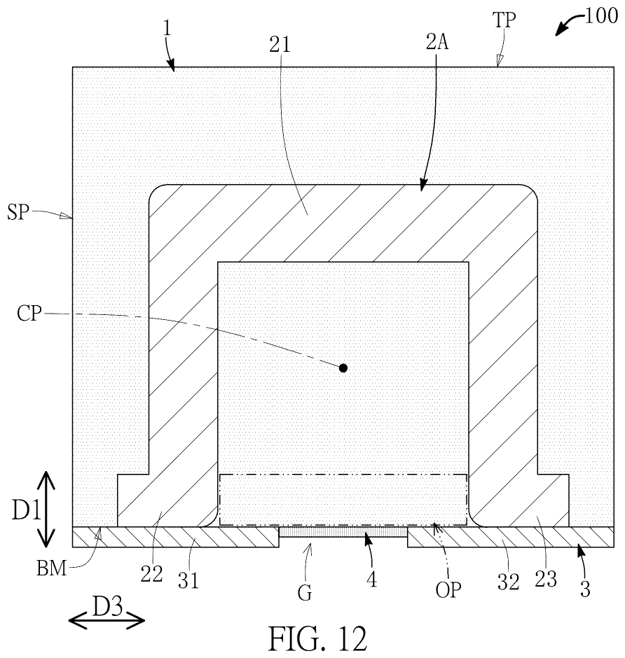

In another embodiment, as shown in FIG. 12, the two ends of each of the single-piece coils 2A can be bent outward, so that the first end portion 22 and the second end portion 23 extend from the main body portion 21 along the third direction D3 away from each other.

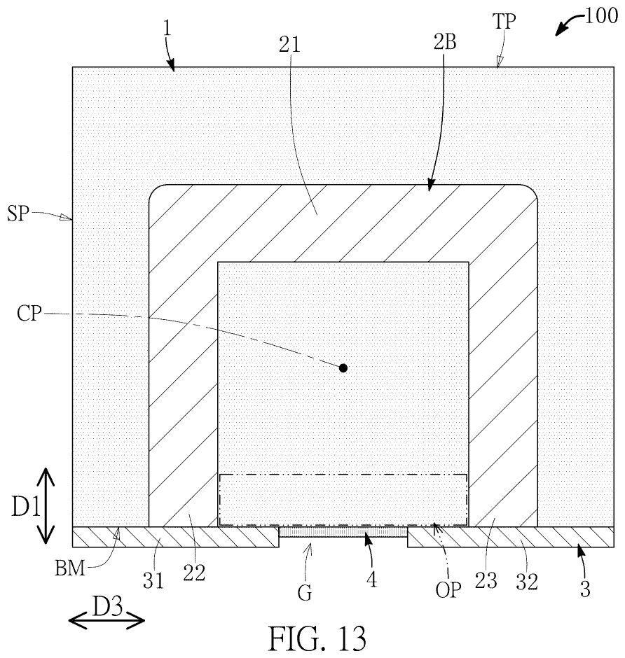

In yet another embodiment, as shown in FIG. 13, the two ends of each of the single-piece coils 2B extend along the first direction D1 without bending, so that the first end portion 22 and the second end portion 23 extend from the main body portion 21 along the first direction D1.

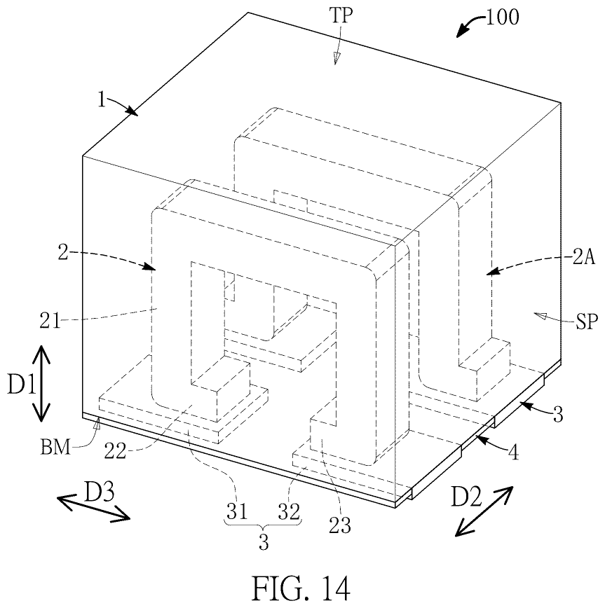

Additionally, it should be emphasized that the magnetic body 1 can accommodate the single-piece coils 2 of different or identical configurations based on practical requirements. For example, in the two single-piece coils 2 of the magnetic body 1, the first end portion 22 and the second end portion 23 of each of the two single-piece coils 2 can either face each other, face away from each other, or be bent to. For another example, as shown in FIG. 14, in the two single-piece coils 2 of the magnetic body 1, the first end portion 22 and the second end portion 23 of one of the two single-piece coils 2 face each other, and the first end portion 22 and the second end portion 23 of another one of the two single-piece coils 2A face away from each other.

Referring again to FIG. 1 to FIG. 3, the first end portion 22 and the second end portion 23 of each of the single-piece coils 2 can be exposed from the bottom surface BM of the magnetic body 1. In other words, part of the first end portion 22 and part of the second end portion 23 are not covered by the magnetic body 1.

Additionally, the first end portion 22 and the second end portion 23 do not protrude from a side of the magnetic body 1 in the third direction D3, or do not extend out from the side of the magnetic body 1 in the third direction D3. Thus, each of the single-piece coils 2 can be electrically connected to the electrode structure 3 located on the surface of the magnetic body 1.

It should be additionally noted that each of the single-piece coils 2 can have a distance between the first end portion 22 and the second end portion 23 adjusted according to the impedance characteristics that are needed, which will not be further elaborated herein.

Referring again to FIG. 2 and FIG. 3, the electrode structure 3 is arranged on the bottom surface BM of the magnetic body 1, and the electrode structure 3 includes a plurality of first electrodes 31 and a plurality of second electrodes 32 that are spaced apart from each other. The first electrodes 31 are electrically coupled to the first end portions 22 of the single-piece coils 2, and the second electrodes 32 are electrically coupled to the second end portions 23 of the single-piece coils 2.

The material of the electrode structure 3 can include, but is not limited to, at least one of copper, nickel, or tin. For example, the material of the electrode structure 3 may be a copper-nickel alloy, a tin-copper alloy, a copper-nickel-tin alloy, or the electrode structure 3 may include a copper layer, a nickel layer, and a tin layer arranged sequentially, where the copper layer is in contact with the first end portion 22 or the second end portion 23.

In one embodiment, each of the first electrodes 31 and the second electrodes 32 is a rectangular sheet structure (i.e., having a rectangular cross-section), and a gap D between any two adjacent ones of the first electrodes 31, between any two adjacent ones of one of the first electrodes 31 and one of the second electrodes 32, and between any two adjacent ones of the second electrodes 32, can optionally be greater than or equal to 0.1 millimeters. However, the shapes of the first electrode 31 and the second electrode 32 of the present disclosure are not limited thereto.

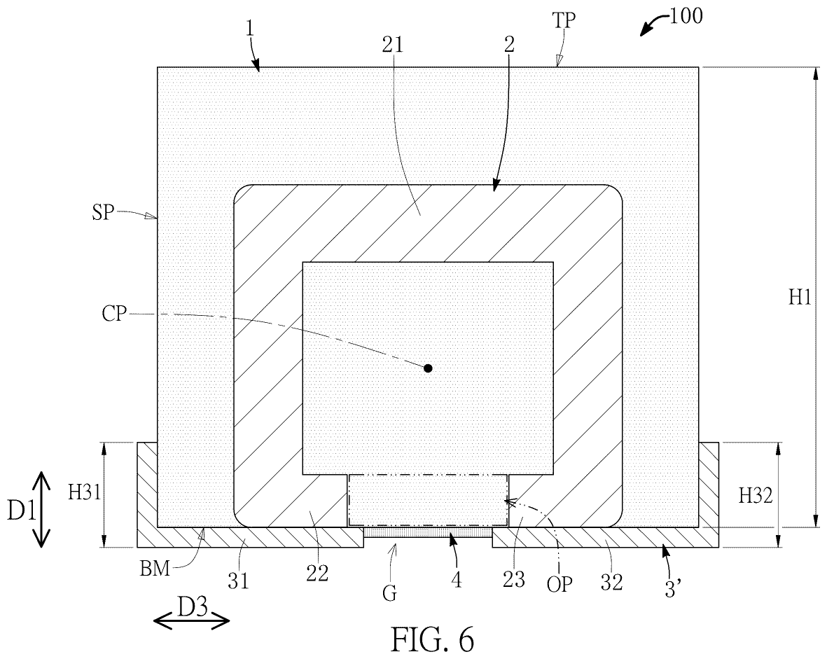

For example, as shown in FIG. 6, in another embodiment, the cross-sections of the first electrodes 31 and the second electrodes 32 are each L-shaped, and the first electrodes 31 are configured to face the second electrodes 32. In other words, each of the first electrodes 31 extends from the bottom surface BM to one of two sides of the magnetic body 1, and each of the second electrodes 32 extends from the bottom surface BM to another one of the two sides of the magnetic body 1.

In the present embodiment, a height H31 of the cross-section of each of the first electrodes 31 along the first direction D1 and a height H32 of the cross-section of each of the second electrodes 32 along the first direction D1 are less than or equal to a height H1 of the magnetic body 1 along the first direction D1.

Optionally, the height H31 of each of the first electrodes 31 and the height H32 of each of the second electrodes 32 along the first direction D1 are greater than or equal to 0.01 millimeters.

Thus, the first electrodes 31 and the second electrodes 32 that are in L-shapes can provide more contact area, so as to increase the bonding strength of the inductor 100 on a printed circuit board.

In practice, a thickness of each of the first electrodes 31 and each of the second electrodes 32 is less than or equal to a thickness of the magnetic body 1. In the present embodiment, the thickness of each of the first electrodes 31 and each of the second electrodes 32 can optionally be greater than or equal to 0.01 millimeters, but the present disclosure is not limited thereto.

Additionally, a groove G is formed between one of the first electrodes 31 and one of the second electrodes 32 adjacent to each other, and the grooves G correspond in position to the openings OP of the single-piece coils 2. In other words, the quantity of the grooves G can be positively correlated with the quantity of the single-piece coils 2, and the grooves G can be arranged along the second direction D2. Thus, the grooves G can provide a solder buffer space to enhance the bonding between the inductor 100 and other components.

In practice, a depth of each of the grooves G along the first direction D1 can be greater than or equal to 0.1 millimeters.

It is worth noting that, to prevent short circuits, the first electrodes 31 and the second electrodes 32 can also be electrically isolated by the protective structure 4.

Specifically, as shown in FIG. 2, FIG. 3, and FIG. 5, the protective structure 4 is arranged on the bottom surface BM of the magnetic body 1, and the protective structure 4 is positioned between the first electrodes 31 and the second electrodes 32. In the present embodiment, the material of the protective structure 4 can be selected from epoxy resin, acrylic resin, or silicone. Naturally, the inductor 100 can also utilize the characteristic that metal cannot be deposited on the protective structure 4, so as to further avoid a situation where the first electrodes 31 and the second electrodes 32 become interconnected during the manufacturing process.

Optionally, a thickness of the protective structure 4 is less than a thickness of the electrode structure 3, so that the electrode structure 3 can protrude relative to the protective structure 4 for facilitating subsequent electrical connections to other components, but the present disclosure is not limited thereto. For example, in certain embodiments of the present disclosure (not shown), the thickness of the protective structure 4 can also be greater than the thickness of the electrode structure 3, so that the electrode structure 3 can be encapsulated within the protective structure 4 (that is, the first electrode 31 and the second electrode 32 of the electrode structure 3 are surrounded by the protective structure 4).

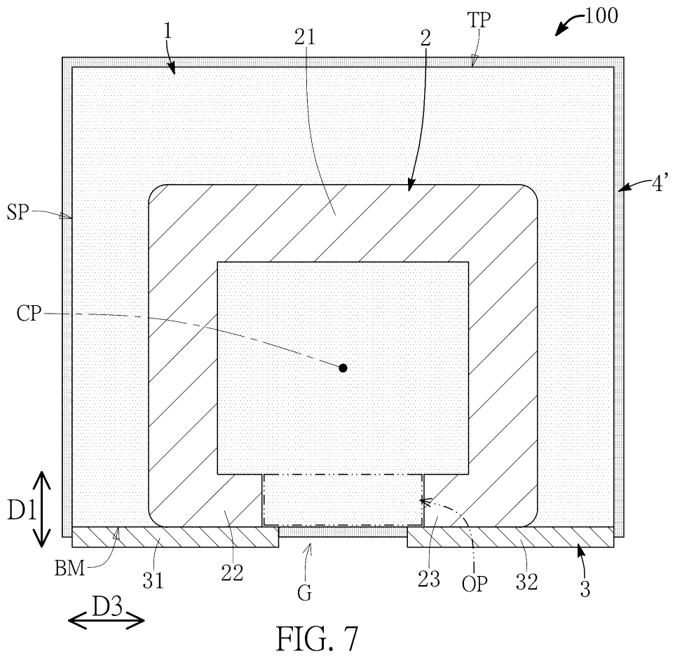

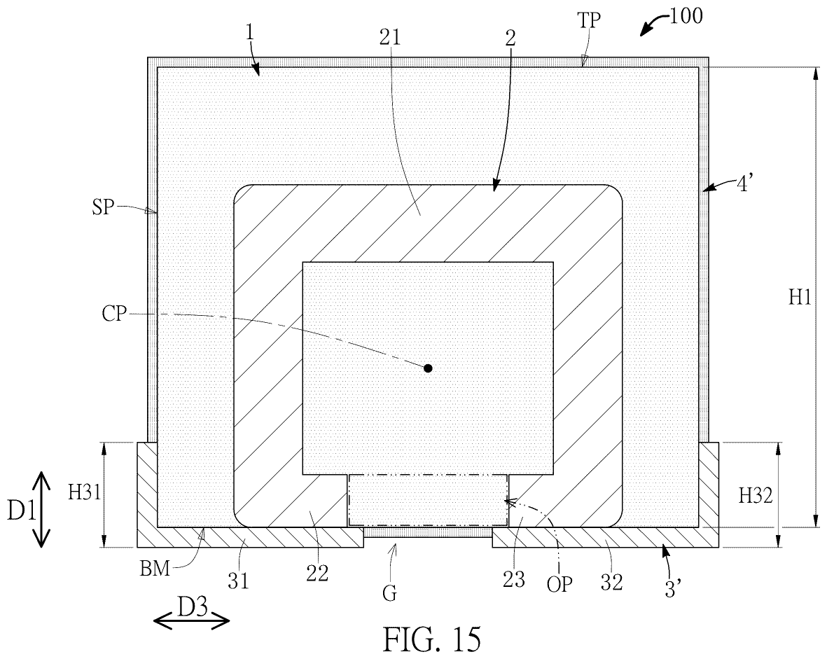

Referring to FIG. 7 and FIG. 15, the protective structure 4′ can also be further arranged on other surfaces of the magnetic body 1, aside from the bottom surface BM. Specifically, the protective structure 4′ can extend from the bottom surface BM to the surrounding surface SP and the top surface TP. The protective structure 4 can jointly encapsulate the magnetic body 1 together with the electrode structure 3, so as to prevent the magnetic body 1 or each of the single-piece coils 2 from contacting with the external environment. Thus, the protective structure 4′ can enhance the insulation, provide rust resistance, and prevent electroplating diffusion of the components.

### Beneficial Effects of the Embodiment

In conclusion, in the inductor provided by the present disclosure, by virtue of “the single-piece coils being embedded in the magnetic body and being spaced apart from each other” and “the first end portion and the second end portion being exposed from the bottom surface,” the inductor can have higher power density under the same volume, so as to improve power conversion efficiency.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An inductor, comprising:
a magnetic body having a bottom surface;
a plurality of single-piece coils embedded in the magnetic body, wherein the single-piece coils are spaced apart from each other, each of the single-piece coils includes a first end portion and a second end portion, and the first end portion and the second end portion are exposed from the bottom surface;
an electrode structure disposed on the bottom surface of the magnetic body, wherein the electrode structure includes:
a plurality of first electrodes spaced apart from each other, wherein the first electrodes are respectively and electrically coupled to the first end portions of the single-piece coils; and
a plurality of second electrodes spaced apart from each other, wherein the second electrodes are respectively and electrically coupled to the second end portions of the single-piece coils; and
a protective structure disposed on the bottom surface of the magnetic body, wherein the first electrodes and the second electrodes are separated by the protective structure.

2. The inductor according to claim 1, wherein the magnetic body has a first direction and a second direction that is perpendicular to the first direction, and the magnetic body has the bottom surface when observed along the first direction; wherein the single-piece coils are spaced apart along the second direction, and two adjacent ones of the single-piece coils have a first minimum separation distance along the second direction.

3. The inductor according to claim 1, wherein the magnetic body has a first direction, a second direction perpendicular to the first direction, and a third direction that is perpendicular to the first direction and the second direction, and the magnetic body has the bottom surface when observed along the first direction; wherein the single-piece coils are spaced apart along the third direction, and two adjacent ones of the single-piece coils have a second minimum separation distance along the third direction.

4. The inductor according to claim 1, wherein the magnetic body has a first direction, a second direction perpendicular to the first direction, and a third direction that is perpendicular to the first direction and the second direction, and the magnetic body has the bottom surface when observed along the first direction; wherein the single-piece coils are spaced apart along the second direction and the third direction; wherein two of the single-piece coils adjacent to each other in the second direction have a first minimum separation distance along the second direction, and two of the single-piece coils adjacent to each other in the third direction have a second minimum separation distance along the third direction.

5. The inductor according to claim 1, wherein the magnetic body has a first direction and a second direction that is perpendicular to the first direction, and the magnetic body has the bottom surface when observed along the first direction; wherein a groove is formed between one of the first electrodes and one of the second electrodes that are adjacent to each other.

6. The inductor according to claim 1, wherein the first end portion and the second end portion of each of the single-piece coils extend toward each other.

7. The inductor according to claim 1, wherein the first end portion and the second end portion of each of the single-piece coils extend away from each other.

8. The inductor according to claim 1, wherein the first end portion and the second end portion of each of a part of the single-piece coils extend toward each other, and the first end portion and the second end portion of each of another part of the single-piece coils extend away from each other.

9. The inductor according to claim 1, wherein the magnetic body includes a top surface opposite to the bottom surface, and a surrounding surface that is connected to the top surface and the bottom surface; wherein the protective structure extends from the bottom surface to the surrounding surface and the top surface, so that the protective structure and the electrode structure jointly cover the magnetic body.

10. The inductor according to claim 1, wherein a cross-section of each of the first electrodes and a cross-section of each of the second electrodes are each L-shaped; wherein each of the first electrodes extends from the bottom surface to one of two sides of the magnetic body, and each of the second electrodes extends from the bottom surface to another one of the two sides of the magnetic body.
